(19) United States
(12) Patent Application Publication
(10) Pub. No.: US 2006/0080168 A1
(43) Pub. Date: Apr. 13, 2006

(54) System and method for managing advertisement by use of advertisement and sanitary paper

(76) Inventor: Liu Min, Kaohsiung City (TW)

Correspondence Address: REED SMITH LLP, Suite 1400, 3110 Fairview Park Drive, Falls Church, VA, 22042, US

(21) Appl. No.: 10/962,431

(22) Filed: Oct. 13, 2004

(51) Int. Cl. G06Q 30/00

(52) U.S. Cl. 705/14

(57) ABSTRACT

A system and method for managing advertisement by use of advertisement and sanitary paper is disclosed in order to change current advertisement marketing management models. Members are recruited and a database about the members is built by an advertisement and distribution manager. The data about the members are analyzed and classified. Enterprises are recruited and a database about the enterprises is built based on the analysis of the data about the members. Assigned by the enterprises, the advertisement and distribution manager prints advertisements on sanitary paper. The advertisement and distribution manager notifies the members of collecting the sanitary paper. Finally, the advertisement and distribution manager provides the enterprises with basic information or questionnaire data about the members in order to finish two-way advertisement marketing management. The advertisement and distribution manager improves advertising effects by means of letting the members read the advertisement on the sanitary paper.

### BACKGROUND OF THE INVENTION

1. Field of the Invention

The present invention relates to advertisement marketing models and, more particularly, to a system and method for managing advertisement by use of advertisement and sanitary paper in order to achieve an aggressive two-way advertisement marketing model.

2. Description of the Related Art

Conventional models of advertisement marketing include distribution of direct mails or broadcast through the media such as newspaper, television, and network. These are a one-way advertisement model and their effects are unpredictable.

To improve the advertising effects, tissue paper printed with advertisement is disclosed in US Patent Application 2004/0003521 A1. While consumers kill time via reading such advertisement printed on tissue paper, advertisement marketing is happening. Yet, this is still a one-way advertisement marketing model and its effects are unpredictable.

Therefore, the conventional models of advertisement marketing such as distribution of direct mails, broadcast through the media and tissue paper printed with advertisement involve one-way advertisement marketing models. They cannot get feedback about the customers' interests for a long time. Their effects are unpredictable.

### SUMMARY OF THE INVENTION

To solve the drawbacks of the above-mentioned conventional models of advertisement marketing, it is therefore the primary objective of the present invention is to change them into an aggressive two-way advertisement marketing model in order to achieve better effects.

A system and method for managing advertisement by use of advertisement and sanitary paper is disclosed in order to change current advertisement marketing management models. Members are recruited and a database about the members is built by an advertisement and distribution manager. The data about the members are analyzed and classified. Enterprises are recruited and a database about the enterprises is built based on the analysis of the data about the members. Assigned by the enterprises, the advertisement and distribution manager prints advertisement on sanitary paper. The advertisement and distribution manager notifies the members of collecting the sanitary paper. Finally, the advertisement and distribution manager provides the enterprises with basic information or questionnaire data about the members in order to finish the two-way advertisement marketing management. The advertisement and distribution manager improves advertising effects by means of letting the members read the advertisement on the sanitary paper.

### BRIEF DESCRIPTION OF THE DRAWINGS

FIG. 1 is a block diagram of a system for managing advertisement according to the preferred embodiment of the present invention;

FIG. 2 is a flow chart of a method for managing advertisement used in the system shown in FIG. 1;

FIG. 3 is a block diagram of a database of members used in the system shown in FIG. 1;

FIG. 4 is a block diagram of a database of enterprises used in the system shown in FIG. 1; and

FIG. 5 is a perspective view of sanitary paper printed with advertisement used in the system shown in FIG. 1.

### DETAILED DESCRIPTION OF PREFERRED EMBODIMENT OF THE INVENTION

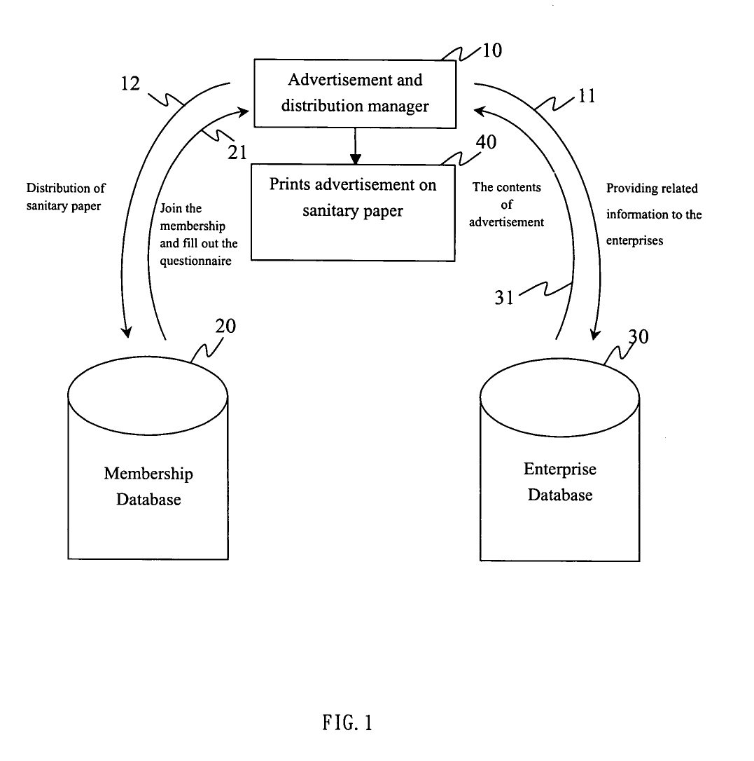

Referring to FIG. 1, a block diagram of a system for managing advertisement according to the preferred embodiment of the present invention, an advertisement and distribution manager 10 executes a two-way advertisement marketing model based on database 20 of members and a database 30 of enterprises. At first, the advertisement and distribution manager 10 recruits members and collects information about the members and questionnaires. The recruiting of members may be conducted in general manners or through baits such as coupons, gifts, money, etc. The advertisement and distribution manager 10 gives each member a proof of collection. The advertisement and distribution manager 10 proceed with advertisement marketing on enterprises. The enterprises may be recruited and the database 30 of the enterprises built via providing the data of the members and the questionnaire tasks 11. The enterprises delegate the advertisement and distribution manager 10. The advertisement and distribution manager 10 prints the contents 31 of advertisement on sanitary paper 40 such as tissue paper, paper napkins, paper for use in kitchens, facial paper and etc. The contents 31 are decided according to the interesting and related information of the members. The enterprises may conduct promotions through providing coupons together with the sanitary paper 40. Through such as mail, telephone, facsimile, e-mail, or fixed locations such as shopping mall, the advertisement and distribution manager 10 may notify the members 20 for collecting the sanitary paper 40 printed with the contents 41 of advertisement for free or at a discounted price 12 in order to increase their willingness to collect the sanitary paper 40. Thus, the members can read the contents 41 of advertisement in kitchens, restrooms, and etc. Of course, the members must provide the proof of collection before collecting the sanitary paper 40 for free or at a discounted price. Non-members have to join the members before they are entitled to the sanitary paper 40 for free or at a discounted price. Based on the enterprises' requirements, the advertisement and distribution manager 10 may proceed with marketing surveys. The advertisement and distribution manager 10 may collect questionnaires from the members, and periodically performs 21. Thus, the enterprises 11 understand the members' needs and run advertisement based on the needs of the members' needs in order to build a two-way model for advertisement marketing. Of course, on the other hand, the enterprises 30 may assign their departments to play the role of the advertisement and distribution manager 10 may be their own enterprise to run this model in order to run advertisement in this two-way model for advertisement marketing.

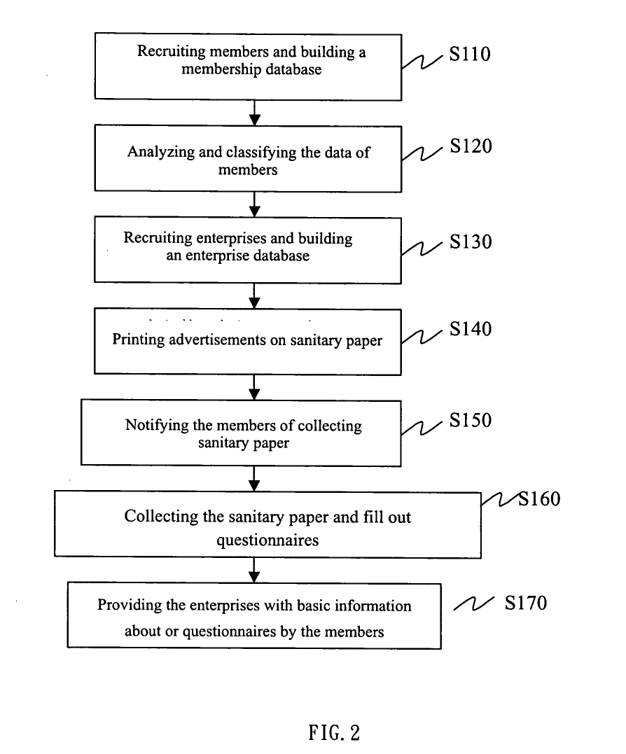

Referring to FIG. 2, a flow chart of a method for managing advertisement used in the system shown in FIG. 1, at step S110, At step S120, the data about the members are analyzed and classified. At step S130, enterprises are recruited and a database about the enterprises is built based on the analysis of the data about the members. At step S140, assigned by the enterprises, the advertisement and distribution manager 10. At step S150, the advertisement and distribution manager 10 notifies the members of collecting the sanitary paper. At step S160, the members, by showing their proof of collections, the members collect the sanitary paper 40 and fill out questionnaires 21. To increase the members' willingness to read the advertisement, the advertisement and distribution manager 10 may provide the sanitary paper 40 for free or at a discounted price. The advertisement and distribution manager 10 may provide coupons together with the sanitary paper 40. Finally, at step S170, the advertisement and distribution manager 10 provides the enterprises with basic information about or questionnaires 21 by the members so as to finish two-way advertisement marketing management.

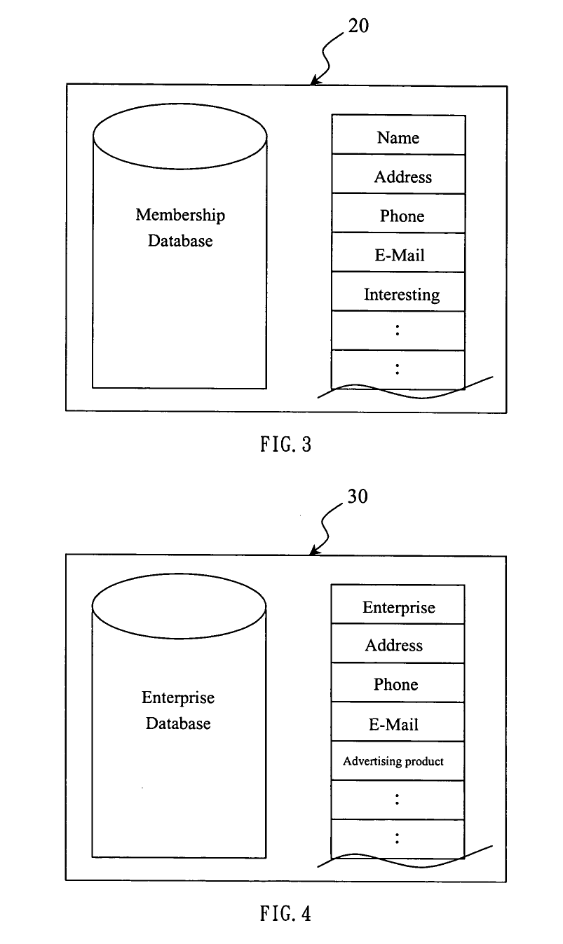

Referring to FIG. 3, the database 20 of the information about the members built by the advertisement and distribution manager 10 may include their names, addresses, telephone numbers, email addresses, interests, demographic data, and etc.

Referring to FIG. 4, the database 30 of the information about the enterprises built by the advertisement and distribution manager 10 may include their names, addresses, telephone numbers, email addresses, products and etc.

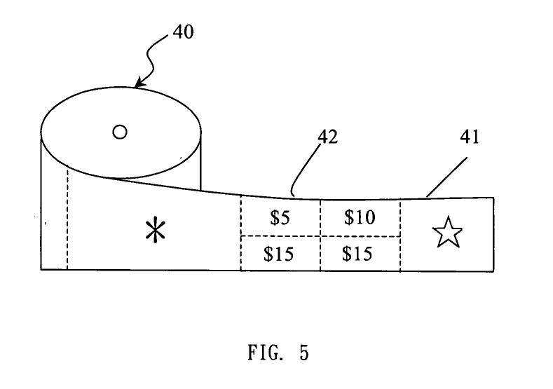

Referring to FIG. 5, the contents 41 of the advertisement printed on the sanitary paper 40 by the advertisement and distribution manager 10 assigned by the enterprises advertisement prints 41, coupons 42, etc., in order to increase the members' willingness to collect the sanitary paper 40 and read the advertisement printed on the sanitary paper 40 in order to improve the effects of the advertisement.

Moreover, to maintain the number of the members and their willingness to collect the sanitary paper 40 printed with the advertisement, the advertisement and distribution manager 10 may determine how much sanitary paper 40 a certain member can collect, which will be based on how long he or she has been a member.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A system for managing advertisement by use of advertisement and sanitary paper in order to conduct a two-way operation between members and enterprises, said system comprising:
an advertisement and distribution manager;
a database of basic information about said members built by said advertisement and distribution manager;
a database of basic information about said enterprises built by said advertisement and distribution manager; and
sanitary paper made by said advertisement and distribution manager,
wherein said advertisement and distribution manager recruits said members and builds said database of basic information about said members and distributes said sanitary paper printed with contents of advertisement and provides said enterprises with two-way advertisement marketing management.

2. The system according to claim 1 wherein said each of members is given a proof of collection.

3. The system according to claim 1 wherein said contents of advertisement of said sanitary paper comprise of coupons or other promotional materials.

4. The system according to claim 1 wherein said sanitary paper comprises tissue paper, paper napkins, or paper for use in kitchens.

5. The system according to claim 1 wherein said advertisement and distribution manager distributes notification for collection by means of mail, facsimile, telephone, or email.

6. The system according to claim 1 wherein said advertisement and distribution manager recruits the members by means of baits.

7. The system according to claim 1 wherein said advertisement and distribution manager may be one of said enterprises.

8. The system according to claim 1 wherein said sanitary paper is provided for free or at a discounted price.

9. A method for managing advertisement by use of advertisement and sanitary paper in order to conduct a two-way operation between members and enterprises, said method comprising the steps of:
recruiting members and building a database of information about the members;
analyzing and classifying the information of the members;
recruiting enterprises and building a database of information about the enterprises;
providing sanitary paper with contents of advertisement;
distributing the sanitary paper to said members; and
providing said enterprises with the information about the members who collect the sanitary paper.

10. The method according to claim 9 wherein said step of recruiting members comprises the step of providing baits to the members.

11. The method according to claim 9 wherein said contents of advertisement comprise coupons or other promotional materials.

12. The method according to claim 9 wherein said contents of advertisement are determined based on the enterprises' needs, interests of the members and statistics data.

13. The method according to claim 9 wherein how much sanitary paper one member can collect depends on how long said member has held the membership.
